(19) United States
(12) Patent Application Publication
(10) Pub. No.: US 2022/0172728 A1
(43) Pub. Date: Jun. 2, 2022

(54) Method for the Automated Analysis of Dialogue for Generating Team Metrics

(71) Applicants: Ian Perera, Pensacola, FL (US); Mathew Johnson, Pensacola, FL (US)

(72) Inventors: Ian Perera, Pensacola, FL (US); Mathew Johnson, Pensacola, FL (US)

(21) Appl. No.: 17/518,973

(22) Filed: Nov. 4, 2021

Related U.S. Application Data
(63) Continuation of application No. 63/109,375, filed on Nov. 4, 2020.

(51) Int. Cl. G10L 17/22; G10L 17/06

(52) U.S. Cl. CPC G10L 17/22; G10L 17/06

(57) ABSTRACT

A system for monitoring intra-team communications to automatically create team performance metrics. In a preferred embodiment, the verbal communications between team members are monitored. The communications are monitored to preferably assign attributes to each individual instance, such as the speaker identity, the recipient identity, the nature of the speech (such as a command or a query), the polarity of the speech (positive or negative), and the relevance of the speech.

### CROSS-REFERENCES TO RELATED APPLICATIONS

This non-provisional patent application claims the benefit—pursuant to 37 C.F.R. §1.53(c) of a previously filed provisional application. The parent application was assigned Ser. No. 63/109,375. It was filed on Nov. 4, 2020 and listed the same inventors.

### STATEMENT REGARDING FEDERALLY SPONSORED RESEARCH OR DEVELOPMENT

Not applicable

### MICROFICHE APPENDIX

Not Applicable

### BACKGROUND OF THE INVENTION

### Field of the Invention

The present invention pertains to the field of evaluating team performance. More specifically, the invention comprises an automated analysis system that monitors intra-team communication and uses this information to evaluate team performance.

### Description of the Related Art

Almost all collaborative tasks involve communication, and the effectiveness of such communication can have significant impacts on the success of the task. Given the vast variety of tasks, the depth of knowledge required to accomplish the task, the range of personalities of the people involved, and the creativity inherent in language use, it can be difficult to quantify when communication is effective independently of the challenges faced in the task itself. The present inventors provide as an example the domain of software development where collaborative conversation occurs in a multi-person text chatroom. The text chatroom in question is the “Slack” business communication platform marketed by Slack Technologies, Inc., of San Francisco, Calif., U.S.A. However, the present invention can be applied to many other domains such as engineering development, construction project management, urban planning, etc. The invention can also be applied with extended sensors capable of doing much more than simply monitoring the language used between team members. These sensors can monitor additional elements such as logins, open documents, contributions to a shared code repository, etc.

Team communication during collaborative tasks has been the subject of prior work but previous methods on evaluation and analysis of team communication have been limited in multiple ways: they either depend on human analysis, or if automated, they typically do not have a means for explainable analysis of the underlying mechanisms of communication and collaboration that are tied to the task. Prior methods have used completion of the task as a signal as to identify positive team communication features (Martin & Foltz, 2004), but the language measures identified are automatically learned, not tied to specific team-performance measures, and require a task that is either completed or failed. In many domains, collaborative tasks do not often “fail”, but rather may go over budget, miss deadlines, or be completed with deficiencies in the final product that are only apparent months or years later.

Other methods of productivity analysis or effort accounting suffer from focusing on quantitative metrics that may not accurately reflect progress and productivity at the appropriate level. For example, frequent comments or lines of code may mean very little in regards to the progress made on a software solution. Given the prevalence of existing libraries and resources, significant contributions to a piece of software may be composed of only dozens of lines of code. Likewise, team management metrics such as frequency of ticket creation or status updates do not necessarily reflect progress without an understanding of the issues being faced or the significance of the effort required to resolve the ticket. Analyzing team discussion provides a much greater insight into collaboration and communication efficiency, as discussions between team members provide a more accurate picture into the significant and meaningful challenges and accomplishments of team members. Furthermore, both teams and individuals can be evaluated according to social and management metrics—e.g., managing frustration, giving praise to increase team morale, taking responsibility for issues and tasks, etc. The present invention monitors these intra-team communications to gain insight into team performance.

### BRIEF SUMMARY OF THE INVENTION

The present invention monitors intra-team communications to automatically create team performance metrics. In a preferred embodiment, the verbal communications between team members are monitored. The communications are monitored to preferably assign attributes to each individual instance, such as the speaker identity, the recipient identity, the nature of the speech (such as a command or a query), the polarity of the speech (positive or negative), and the relevance of the speech.

### BRIEF DESCRIPTION OF THE SEVERAL VIEWS OF THE DRAWINGS

FIG. 1 depicts the automated monitoring of intra-team communications.

FIG. 2 presents a block diagram showing an exemplary implementation of the inventive process.

### DETAILED DESCRIPTION OF THE INVENTION

In a first embodiment, the inventors have developed (1) an annotation method (or “scheme”) to categorize sentences into speech acts relevant for collaborative communication analysis, (2) an initial set of metrics that provide a means for generating actionable analysis from a sequence of speech acts, and (3) a prototype system that uses a softmax neural network to automatically classify speech acts according to a prior, more basic classification system.

The inventors have developed the provided annotation scheme (Annotation Guide v1.pdf) in such a way that a natural language processing system (known as a “sentence classifier”) can assign the correct speech act (from a reduced, simpler set of speech acts) to a sentence expressed in text (or transcribed, manually or automatically, from speech), given the sentence text itself and prior speech acts to establish context. These speech acts are also designed hierarchically, so that the sentence classifier can fall back to more general speech acts when unsure of the correct act to label a sentence as.

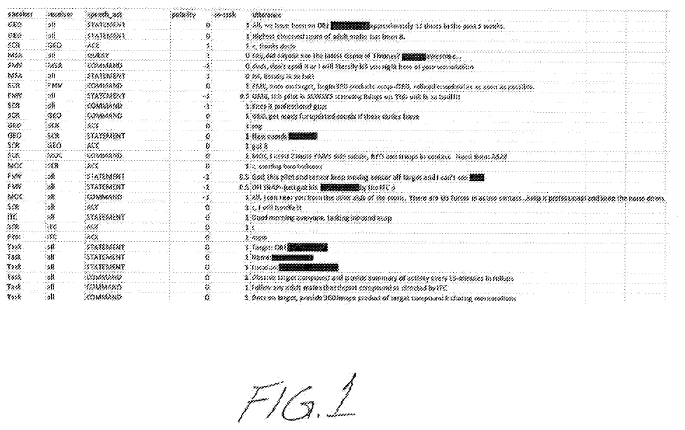

The attached FIG. 1 shows spoken words that are captured and annotated for intra-team communications regarding an aerial surveillance task. This example used a human language classifier, though other embodiments can automate this task. The example shown used the Spacy Natural Language Processing (NLP) Toolkit to train a sentence classifier that can identify the speech act of team dialogue during the task of directing the actions of an unmanned aerial vehicle (a UAV task). From these classified sentences, various metrics can be automatically generated based on a human-interpretable rule. For example, one metric would be whether a QUERY is followed up by an ACK (ACKNOWLEDGEMENT) or a STATEMENT—indicating to an analyst whether communication channels are consistent and effectively used.

The input information depicted is a verbal utterance by a team member. These are shown under the “utterance” column. The speaker of each utterance is identified, along with the intended receiver. The speaker can be identified by the source of the utterance (a particular microphone is used by a particular speaker at a particular workstation). A polarity is assigned to each utterance, with a positive value indicating a positive sentiment and a negative value indicating a negative sentiment. The “on task” parameter indicated the relevance of the utterance to the task at hand. value between 0 and 1 can be assigned.

FIG. 1 includes a variety of acronyms and other terms well known to those skilled in the art. To benefit the reader's understanding, the following section explains these acronyms and terms:

ACK Acknowledgement

MOC Mission Operations Commander (responsible for operations of multiple vehicles)

Pilot The person controlling the flight operations of the UAV being controlled

MSA Staff person assigned to the operation of the UAV in this instance

GEO Group Executive Officer

SCR Overall commander of operations of the UAV in this instance

FMV Full Motion Video operator

ITC ISR Tactical Controller (ISR stands for Intelligence, Surveillance, and Reconnaissance.)

Task Command authority issuing a fragmentary air tasking order

In many instances the members of the team will not have the same status. In the example depicted, the team members are attempting to Observe a specified location and provide images including full motion videos. “MOC” stands for Mission Operations Commander. The reader will note how requests for additional assets are made to the MOC and how the MOC reprimands sonic of the team members for irrelevant chatter.

The types of speech are classified according to the following Speech Act Types:

STATEMENT—Conveys information about the current environment, task, or some other information which may or may not be in response to a question, e.g. “1215z, blue forces observed approximately 300 m east of compound on foot.”

QUERY—A question about the environment, task, or some other information, with the expectation of a response. e.g., “which main facility?”

COMMAND—A directive for the listener(s), e.g. “Pilot, adjust sensor 100 m east ASAP.”

ACK—Acknowledgement of a COMMAND or STATEMENT (“Roger, adjusting sensor 100 m east”) or a positive response to a QUERY (“Yes, sir”).

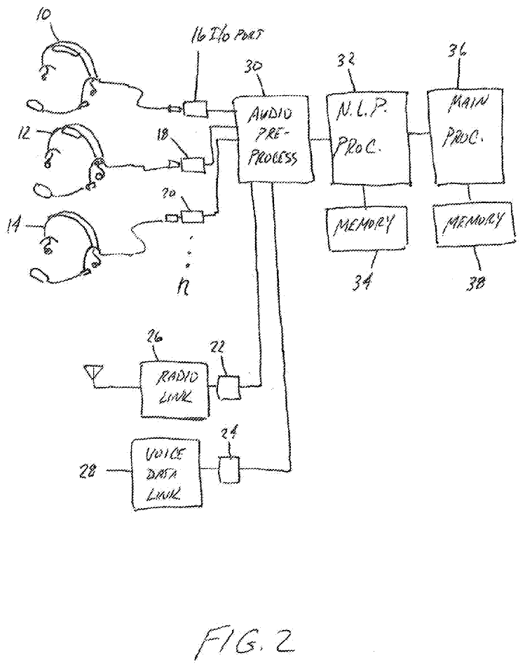

FIG. 2 provides a depiction of a system used to carry out the inventive method. Verbal utterances are captured by a headset microphone presently being worn by users 10, 12, 14. Many additional users may also be present (indicated by the expansion to n users). In addition, verbal utterances may be brought into the system by one or more radio links 26 and one or more voice data links 28. These verbal communications are fed into audio pre-processor 30 by multiple I/O ports 16-24.

Audio pre-processor 30—which preferably operates in the digital domain—filters the incoming voice data and adjusts its level in order to provide a clean input for natural language processor 32. Natural language processor 32 converts the incoming audio files to text files. Memory 34 contains the software to be run and a database that can be supplemented over time to improve performance. A specific ontology germane to the activity being monitored is preferably created and stored. As an example, an ontology specific to the operation of UAVs can be used.

Natural language processor 32 preferably feeds its information to main processor 36, which also has an associated memory 38. As those skilled in the art will know, the various components 30-38 can be incorporated in a single suitable computer. In that instance a single processor or set of processors may be used for the natural language processing and other functions. Thus, the term “processor” includes embodiments using a single processor or multiple processors, running on a single computer or multiple computers.

The system of FIG. 2 takes in speech instances such as shown in FIG. 1 and processes them. The inventive system is preferably configured to perform the following operations:

1. Identify the speaker usually by assigning a particular speaker to a particular input device—such as a microphone on a headset plugged into a particular workstation.

2. Identify the intended recipient of the particular utterance. As many of the utterances will be on a common “intercom” heard by many users, the indented recipient must often be determined from the nature of the statement and the present context. Natural language processing is generally used for this task.

3. Identify the type of speech for each utterance (STATEMENT, QUERY, COMMAND, ACK).

4. Assign a polarity to each utterance.

5. Assign an on-task parameter to each utterance. The on-task parameter evaluates whether the utterance is relevant to the task at hand. It is determined as a numerical value ranging between 0 (irrelevant to the task at hand) and 1 (entirely relevant to the task at hand).

In reviewing the example in that attached figure, the reader will note how each instance (an utterance) is classified according to the type of speech. Additional attributes are also assigned as described previously (speaker, receiver, polarity, and whether the statement is on-task (relevant)).

The invention can incorporate many other features and improvements. These include:

1. Expanding the range and specificity of the speech acts that can be detected via automatic Natural Language Processing methods. This will entail using more sophisticated language models that can consider context (prior utterances from team members) to determine the correct speech act to use in labeling utterances.

2. Performing additional NLP to track issues and tasks to determine the current focus of development work, team member expertise, and sentiment to determine levels of comradery and possible friction between team members.

3. Developing more sophisticated team measures while preserving interpretability of metrics to facilitate human-in-the-loop analysis.

4. Incorporating other sensors or indicators (support tickets, repository commits, etc.) into automatic generation of team measures

The preceding description contains significant detail regarding the novel aspects of the present invention. It should not be construed, however, as limiting the scope of the invention but rather as providing illustrations of the preferred embodiments of the invention. Thus, the scope of the invention should be fixed by the claims ultimately drafted, rather than by the examples given.

Having described our invention, we claim:

1. A method for automatically analyzing dialogue between a plurality of users engaged in a particular task, comprising:
(a) providing a processor with an associated memory, said processor running software;
(b) providing each utterance from each of said plurality of users to said processor;
(c) using said processor to identify a particular user who uttered each utterance;
(d) using said processor to identify an intended receiver for each utterance;
(e) using said processor to assign a type of speech for each utterance;
(f) using said processor to assign a polarity for each utterance; and
(g) using said processor to assign an on-task parameter value for each utterance.

2. A method for automatically analyzing dialogue between a plurality of users as recited in claim 1 wherein said type of speech comprises a statement, an acknowledgement, a query, and a command.

3. A method for automatically analyzing dialogue between a plurality of users as recited in claim 1 further comprising presenting a result of said operations in a tabular form.

4. A method for automatically analyzing dialogue between a plurality of users as recited in claim 2 further comprising presenting a result of said operations in a tabular form.

5. A method for automatically analyzing dialogue between a plurality of users as recited in claim 1 wherein said identification of said user who utters a particular utterance is done by determining a microphone that received said utterance.

6. A method for automatically analyzing dialogue between a plurality of users as recited in claim 1 wherein said processor uses natural language processing to determine an intended receiver for each utterance.

7. A method for automatically analyzing dialogue between a plurality of users as recited in claim 1 wherein said processor uses natural language processing to determine a type of speech for each utterance.

8. A method for automatically analyzing dialogue between a plurality of users as recited in claim 1 wherein said processor uses natural language processing to determine a polarity for each utterance.

9. A method for automatically analyzing dialogue between a plurality of users as recited in claim 1 wherein said processor uses natural language processing to determine an on-task parameter value for each utterance.

10. A method for automatically analyzing dialogue between a plurality of users as recited in claim 2 wherein said processor uses natural language processing to determine a type of speech for each utterance.

11. A method for automatically analyzing dialogue between a plurality of users engaged in a particular task. comprising
(a) providing a processor with an associated memory, said processor running software;
(b) providing each utterance from each of said plurality of users to said processor;
(c) using said processor to identify a particular user who uttered each utterance;
(d) using said processor to assign a type of speech for each utterance;
(e) using said processor to assign a polarity for each utterance; and
(f) using said processor to assign an on-task parameter value for each utterance.

12. A method for automatically analyzing dialogue between a plurality of users as recited in claim 11 wherein said type of speech comprises a statement, an acknowledgement, a query, and a command.

13. A method for automatically analyzing dialogue between a plurality of users as recited in claim 11 further comprising presenting a result of said operations in a tabular form.

14. A method for automatically analyzing dialogue between a plurality of users as recited in claim 12 further comprising presenting a result of said operations in a tabular form.

15. A method for automatically analyzing dialogue between a plurality of users as recited in claim 11 wherein said identification of said user who utters a particular utterance is done by determining a microphone that received said utterance.

16. A method for automatically analyzing dialogue between a plurality of users as recited in claim 11 wherein said processor uses natural language processing to determine an intended receiver for each utterance.

17. A method for automatically analyzing dialogue between a plurality of users as recited in claim 11 wherein said processor uses natural language processing to determine a type of speech for each utterance.

18. A method for automatically analyzing dialogue between a plurality of users as recited in claim 11 wherein said processor uses natural language processing to determine a polarity for each utterance.

19. A method for automatically analyzing dialogue between a plurality of users as recited in claim 11 wherein said processor uses natural language processing to determine an on-task parameter value for each utterance.

20. A method for automatically analyzing dialogue between a plurality of users as recited in claim 12 wherein said processor uses natural language processing to determine a type of speech for each utterance.
